(19) United States
(12) Patent Application Publication
(10) Pub. No.: US 2025/0053753 A1
(43) Pub. Date: Feb. 13, 2025

(54) Dense Video Object Captioning from Disjoint Vision

(71) Applicant: Google LLC, Mountain View, CA (US)

(72) Inventors: Xingyi Zhou, Kirkland, WA (US); Anurag Arnab, Grenoble (FR); Chen Sun, San Francisco, CA (US); Cordelia Luise Schmid, Saint-Ismier (FR)

(21) Appl. No.: 18/448,508

(22) Filed: Aug. 11, 2023

(51) Int. Cl. G06F 40/40; G06T 7/246; G06V 10/22; G06V 10/774; G06V 10/776; G06V 20/40

(52) U.S. Cl. CPC G06F 40/40; G06T 7/246; G06V 10/225; G06V 10/774; G06V 10/776; G06V 20/46; G06T 2207/10016; G06T 2207/20081; G06T 2207/30241

(57) ABSTRACT

Provided are a new task and model for dense video object captioning—detecting, tracking, and captioning trajectories of all objects in a video. This task unifies spatial and temporal understanding of the video, and requires fine-grained language description. Example implementations of the proposed model for dense video object captioning can be trained end-to-end and can include different models for spatial localization, tracking, and captioning. As such, some example implementations of the present disclosure can train the proposed model with a mixture of disjoint tasks, and leverage diverse, large-scale datasets which supervise different parts of an example proposed model. This results in noteworthy zero-shot performance.

### FIELD

The present disclosure relates generally to machine learning. More particularly, the present disclosure relates to the use of machine learning models to perform dense video object captioning.

### BACKGROUND

In recent years, video content has become ubiquitous in many aspects of everyday life. The prevalence of digital cameras, smartphones, and other video capture devices, combined with the exponential growth in online video sharing platforms, has led to an explosion in the amount of video data available. However, processing and analyzing this vast amount of video data is a significant challenge.

Automated video analysis has been introduced as a solution to this problem. Existing technologies typically involve techniques such as motion detection, object recognition, and facial recognition. However, these methods have their limitations. For example, they may struggle with complex scenarios involving multiple objects or rapid movement. In addition, current systems are often computationally intensive, requiring significant resources to operate effectively.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method to perform dense video object captioning, the method comprising: obtaining, by a computing system comprising one or more computing devices, a video comprising a plurality of image frames, wherein the video depicts a plurality of objects; respectively processing, by the computing system, each image frame with a machine-learned object detection model to extract one or more sets of feature data respectively for one or more of the plurality of objects that are depicted in the image frame; processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object; respectively processing, by the computing system, at least some of the respective sets of feature data that correspond to each object with a machine-learned text generation model to generate a textual caption for each object; and providing, by the computing system, the textual caption for each object as an output.

Another example aspect of the present disclosure is directed to one or more non-transitory computer-readable media that store computer-readable instructions that, when executed by a computing system, cause the computing system to perform operations. The operations include obtaining, by the computing system, a video comprising a plurality of image frames, wherein the video depicts a plurality of objects. The operations include respectively processing, by the computing system, each image frame with a machine-learned object detection model to extract one or more sets of feature data respectively for one or more of the plurality of objects that are depicted in the image frame and to generate a set of bounding boxes and detection scores for the plurality of objects. The operations include processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object. The operations include obtaining, by the computing system, a textual query. The operations include identifying, by the computing system based on the set of bounding boxes and detection scores and using a machine-learned text generation model, one or more bounding boxes with a highest weighted likelihood for the textual query.

Another example aspect of the present disclosure is directed to a computing system comprising one or more processors and one or more non-transitory computer-readable media that store computer-readable instructions that, when executed by the one or more processors, cause the computing system to perform operations. The operations include obtaining, by the computing system, a video comprising a plurality of image frames, wherein the video depicts a plurality of objects. The operations include respectively processing, by the computing system, each image frame with a machine-learned object detection model to extract one or more sets of feature data respectively for one or more of the plurality of objects that are depicted in the image frame. The operations include processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object. The operations include respectively processing, by the computing system, at least some of the respective sets of feature data that correspond to each object with a machine-learned text generation model to generate a textual caption for each object. The operations include providing, by the computing system, the textual caption for each object as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example dense video object captioning model according to example embodiments of the present disclosure.

FIG. 2 depicts a graphical diagram of an example dense video object captioning model according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to a new task and model for dense video object captioning, which can include detecting, tracking, and captioning trajectories of all objects in a video. This task unifies spatial and temporal understanding of the video, and requires fine-grained language description. Example implementations of the models proposed herein for dense video object captioning can be trained end-to-end and can include different models for spatial localization, tracking, and captioning. As such, some example implementations of the present disclosure can train the proposed model with a mixture of disjoint tasks, and leverage diverse, large-scale datasets which supervise different parts of a proposed model. This results in noteworthy zero-shot performance. Moreover, by finetuning a model from this initialization, performance can be further improved, surpassing strong image-based baselines by a significant margin.

More particularly, the present disclosure proposes the new task of dense video object captioning (dense VOC)—the task of generating captions of object trajectories in a given video. Dense video object captioning is a task that goes beyond standard video captioning. In standard video captioning, the task is to describe the whole video content with one or several sentences. However, dense video object captioning focuses on identifying and describing each individual object and their actions in the video with textual captions. Dense video object captioning has a number of applications, including video content search and improving accessibility for visually impaired persons.

Dense video object captioning is technically challenging for several reasons. It not only requires successful detection and continuous tracking of multiple objects within a video, but also requires understanding complex interactions between these objects over time. Video data is often voluminous and high-dimensional, with significant temporal dependencies, and any slight inaccuracies can propagate and affect the final captions generated. Additionally, the task of generating coherent, semantically-rich sentences that describe the actions and events of these detected objects involves complex natural language understanding and generation. It also needs to handle the variability of video content which can range from simple, single-object actions to complex, multi-object interactions in diverse settings.

The present disclosure provides new model architectures and training frameworks to perform the task of dense VOC. In particular, one aspect of the present disclosure is directed to an end-to-end model that detects objects in a video, tracks them throughout the video, and also generates a textual description of each object trajectory. Specifically, some implementations of the proposed model first use an object detection model to produce class-agnostic region proposals separately for each frame, followed by an association-based tracking model to group objects into trajectories. Features can then be sampled from the object trajectory and fed into an autoregressive language decoder to generate captions for each trajectory. The dense VOC task is therefore a superset of independent tasks—namely object detection, multi-object tracking, and captioning. While separate models could be utilized for each task, the end-to-end trained models proposed herein can produce more temporally coherent captions and capture object motions and object interactions. For example, the proposed model can predict a global caption per trajectory, which significantly reduces “caption switches” compared to captioning per frame.

However, datasets with captioned object trajectories are scarce. Therefore, additional aspects of the present disclosure demonstrate how the proposed models can be trained without any full annotations by using a mixture of disjoint tasks and datasets which supervise different parts of the model. As one example, the COCO dataset can be used for object detection and tracking, the Visual Genome dataset can be used for dense image captioning, and the Spoken Moments in Time dataset can be used for video captioning. An example model trained on these disjoint datasets can perform the dense VOC task zero-shot without access to any full, captioned object trajectories during training. Furthermore, it can also serve as a powerful initialization for finetuning.

Although the present disclosure is the first to study the dense VOC task, existing video grounding datasets can be repurposed for evaluation and domain-specific finetuning. For example, the VidSTG and Video Localized Narratives (VLN) datasets, originally designed for spatio-temporal sentence grounding—the task of finding the object tube in the video given a sentence query—contain (non-exhaustive) annotations for captioned object trajectories. These annotations can be repurposed for the dense VOC task by not using the sentence queries as inputs, but rather as expected model outputs. This means that the dense VOC task is more general and harder than the original grounding task, and models trained on the dense VOC task can be directly applied to grounding by selecting the bounding boxes with the maximum likelihood of generating the query sentence. Also developed are evaluation metrics for the full dense VOC task, which evaluate the captioning, detection and tracking abilities of the model.

Example experiments show that an end-to-end trained Dense VOC model as proposed herein outperforms a recent, strong per-frame baseline followed by an offline tracker by a substantial margin, especially on the temporal consistency of the captions. Moreover, significant improvements are achieved from the disjoint, multi-dataset training. Furthermore, by directly applying the proposed generative captioning model to the discriminative grounding task, it is able to outperform dedicated spatial grounding models on both VidSTG and VLN datasets.

The systems and methods of the present disclosure provide a number of technical effects and benefits. As one example, the disclosed model addresses the technical challenges in dense video object captioning with an integrated end-to-end model. The model employs a machine-learned object detection model for accurate spatial localization of objects in each frame, a tracking model for generating coherent object trajectories, and a text generation model for producing textual captions. These models work together to tackle the high-dimensional, voluminous nature of video data, as well as overcome potential inaccuracies and/or temporal dependencies in video data analysis. Additionally, the model can ensure temporal coherence of the captions by generating a global caption per object trajectory, significantly reducing caption switches for improved clarity.

Another technical benefit is the ability to perform joint training on diverse, large-scale datasets. For example, different losses can be used, each supervising different parts of the model. This enables the model to handle the inherent variability and complexity of video content. Furthermore, example implementations of the model exhibit strong zero-shot performance, and therefore represent a solution to the scarcity of datasets with captioned object trajectories. This ability allows the model to generate dense video object captions without needing to train on fully captioned object trajectories. The proposed models are therefore adaptable and scalable to real-world applications.

As another example technical effect, the proposed dense video object captioning method enhances computational efficiency by unifying object detection, tracking, and captioning into one model, reducing the need for separate resource-intensive models. In particular, instead of employing separate models for each task that would require independent processing and more computational resources, this proposed approach allows for integrated data flow through different model components, eliminating unnecessary inter-process communication and data transfers. Further, by generating a single caption per object trajectory, rather than per frame, the proposed approach lessens the frequency of demanding captioning tasks. Thus, the proposed techniques optimize processor cycles, memory usage, and network usage, providing a more resource-efficient solution.

With reference now to the Figures, example embodiments of the present disclosure will be discussed in further detail.

### Example Techniques

### Example Setting and Notation

The task of image captioning maps an input image, I^{H×W×3}, to a caption c=(y₁, y₂, . . . , yₙ_{ₜ}) which is a sequence of up to nₜ text tokens from a given vocabulary. One example set of components is an image encoder, followed by a text decoder. The encoder maps the input image I, to a feature representation f∈ [symbol] ⁿ^{ᵥ}^{×d} consisting of nᵥ tokens with dimensionality d. The subsequent text decoder can be auto-regressive—it predicts the next text token, yᵢ, as a function of both the image features, f, and previously generated text tokens, y_{1:i-1}, denoted by yᵢ=Decode(f, y_{0:i-1}). Note that the first step of decoding can begin with y₀=BOS, a special beginning-of-sentence token, and the caption ends when the end-of-sentence token, EOS, is output by the model.

This style of image captioning model has been demonstrated to be effective and scalable, achieving state-of-the-art results across a number of captioning datasets. Another possible approach is to use a region proposal network to produce a set of K class-agnostic bounding boxes, b₁, b₂, . . . , b_{K}. Features corresponding to each of these regions can be obtained using RoIAlign, resulting in a localized feature, fₓ= [symbol] ^{r×r×d} where r=7 is the output resolution of RoIAlign. Each of these grid features can be flattened into fₖ∈ [symbol] ^{r}^{²}^{×d} and decoded independently by the text decoder. One possible loss that can be used consists of L=L_{object}+L_{caption} where L_{caption} is a cross-entropy loss over all text tokens in the vocabulary, and L_{object} consists of bounding box regression and objectness terms, as standard in object detection literature.

Next, some example implementations are discussed which extend object captioning to videos, by tracking proposals over time, aggregating trajectory features, and captioning trajectories, in an end-to-end fashion.

### Example End-to-End Tracking

Some example implementations first produce object proposals separately for each frame. Tracking aims to assign each object in each frame a unique trajectory identity δ∈ [symbol] . Some example implementations define fₖ^{t}∈ [symbol] ^{r}^{²}^{×d} as the ROI feature of object k in frame t; F={fₖ^{t}}_{t=1,k=1}^{T,K}^{ₜ} as the concatenation of all object features in the video; and M=|F|=Σₜ₌₁^{T}Kₜ, where Kₜ is the number of objects at the t^{th} frame.

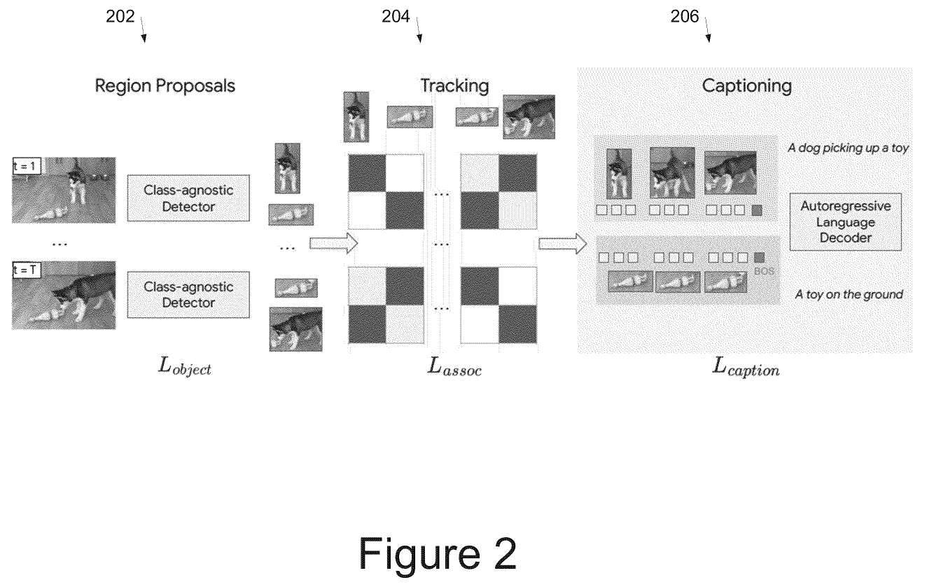

From these object features F, an example proposed network predicts a global association matrix, A∈ [symbol] ^{M×M}, where Aᵢⱼ=1 if the objects denoted by the i^{th} row and j^{th} column respectively, are from the same trajectory at different time steps (as shown in FIG. 2 middle). Otherwise, Aᵢⱼ=0 meaning that these objects are from different trajectories, or at least one of them is background.

Some example implementations use a transformer [symbol] with two self-attention layers to predict the association matrix A=σ( [symbol] (F)), where σ is the sigmoid activation. For the ground truth supervision, some example implementations construct Ā where Āᵢⱼ=1 if and only if the row i and column j of A are matched to the same ground truth trajectory using an Intersection over Union (IoU) criteria of 0.5. The training loss L_{assoc} for this module can, for example, be a binary cross entropy between A and Ā,

$${L}_{assoc} = \frac{1}{M} {\sum }_{ij} BCE ( {A}_{ij} , {\overline{A}}_{ij} ) .$$

To obtain the object identities {δₖ^{t}}_{t=1,k=1}^{T,K}^{ₜ}, needed for tracking evaluation, some example implementations perform a greedy grouping algorithm taking A as input. An example proposed algorithm greedily extracts the longest trajectories from untracked objects, until there are no possible associations (indicated by the association score being above a threshold θ), and guarantees each trajectory has at most one object in each frame.

One example greedy algorithm can be performed to decode an association score matrix into identities of objects. To make the input shape consistent across training iterations, some example implementations zero-pad or truncate the number of objects in each frame Kₜ to the same number, e.g., K=16. An example trajectory ID assignment algorithm is shown below:

Algorithm 1: Greedy assignment of identities from an association matrix.

| | |
|---|---|
| Input | : Number of frames T |
| | Number of objects per frame K |
| | Association Matrix A ∈ [symbol] ^{TK×TK} |

Hyper parameters : Association score threshold θ

| | |
|---|---|
| Output | : Identities for each object δ ∈ [symbol] ^{TK} |

| | |
|---|---|
| M ← T × K | // Number of total objects. |

| | |
|---|---|
| A ← preprocess(A) | // Preprocess A to ensure objects in the same frame have a score of 0. |

| | |
|---|---|
| A ← (A ≥ θ).astype(bool) | // Create binary matrix for possible merges. |

| | |
|---|---|
| δ ← zeros(M) | // Initialize outputs, shape (Mᵢ) |

| | |
|---|---|
| id_count ← 0) | // Initialize ID count. |

while Â.any( ) do

| | |
|---|---|
| \| track_len ← Â.sum(axis=1) | // Compute number of objects in each merge. |

| | |
|---|---|
| \| i ← track_len.argmax( ) | // Find the longest track to merge. |

| | |
|---|---|
| \| id_count ← id_count + 1 | // Create a new identity. |

| | |
|---|---|
| \| δ ← δ + id_count * Âᵢ | // Assign the current track a new ID using Âᵢ as the binary mask. |

| | |
|---|---|
| \| Â ← Â − Âᵢ,\|A,ᵢ | // Remove merged indices from the binary matrix. “\|” is the logical-or. |

end
return δ

### Example Trajectory Captioning

Given the pairs of object features and identities (fₖ, δₖ), some example implementations perform one or both of the following strategies to caption them:

Hard aggregation. Let f_{τ}={fₖ}_{k∈{δ}_{ₖ}_{=τ}} be the set of all object features with identity τ, some example implementations generate a single trajectory caption from f_{τ}. As a video can be long, it is expensive to naively use the entire f_{τ}. Therefore, some example implementations uniformly sample a subset of frames in the trajectory. Specifically, denote this as g_{τ}=UniformSample(f_{δ}, m), where g_{τ}∈ [symbol] ^{m×r}^{²}^{×d}, where m is the number of sampled frames. Some example implementations set m=6. Some example implementations then autoregressively predict the output caption y, where yᵢ=Decode(g, y_{0:i-1}). Note that the language decoder can in some implementations have the same parameters as single-frame object captioning, but processes more input tokens. As a result, it can be trained in the same manner with a softmax cross-entropy loss over the vocabulary of text tokens, denoted by L_{caption}.

Soft aggregation. An alternative to concatenating features of a track as done above, is to compute a weighted sum of features in the same track from other frames. In fact, the association matrix A already serves as a trajectory feature aggregation weight. Some example implementations set

$${F}^{′} = \frac{A}{‖ A ‖} \cdot F ,$$

where · denotes matrix multiplication, and ∥·∥ normalizes A by rows. Each row in F′, fₖ, is an object feature smoothed by its trajectory. Some example implementations then feed each fₖ to the language decoder and generate caption y. This smoothes object features in a frame using other frames in the trajectory. Again, some example implementations do not introduce new parameters and use the same language decoder and loss L_{caption}.

### Example Pretraining With Disjoint Subtasks

In some implementations, the proposed model can be trained with the loss function, L=L_{object}+L_{assoc}+L_{caption}. Note that to avoid additional hyperparameters, some example implementations do not weight each loss term separately. This section describes how some example implementations can decompose the full Dense VOC task into subtasks, and train each on different datasets, as shown in Table 1. This enables the proposed systems to leverage more data, and to also perform the final task in a zero-shot manner (e.g., without any full dense video object captioning annotations).

Object detection. Using detection datasets for images, some example implementations can train the region proposal generator of an example proposed model by L_{object}. Some example implementations use COCO as it is the most popular dataset for this task.

Dense captioning in images. Dense object captioning datasets of images allow example implementations to train both the region proposal generator and the text decoder, by supervising L_{object} and L_{caption}. For example, some example implementations can use Visual Genome, as it contains dense annotations for different regions. Note that these regions can include “stuff” classes like “sky”, or parts of objects, like clothes on a person. Although this enriches the object types that can be detected, it also differs from the vocabulary of other datasets, introducing a domain shift.

Global video captioning. Video captioning datasets help to reduce the domain gap to the final task by also training on video. In particular, some example implementations use Spoken Moments in Time (SMIT) which is the largest dataset for this task and contains narrations for short clips (roughly 3 seconds). As there are no object annotations, but only video-level captions, some example implementations construct a region proposal from the entire frame and caption that with an example proposed text decoder, applying the same L_{caption}. Note that in some examples, the tracking model is effectively an identity function as some example implementations only have a single region proposal per frame.

Tracking. Training the tracking model of an example proposed network can be performed using annotations that associate detections of an object identity throughout the video. It was found that existing tracking datasets either have too limited vocabularies for general objects (MOT, KITTI, YouTube VIS), or are too small (TAO and UVO label 600 and 5000 videos respectively). As a result, some example implementations instead augment image datasets into tracking ones by applying two different data augmentations to the same image, and then linearly interpolating the frames in between to form a pseudo-video. This allows the application of L_{assoc} and L_{object} when training an example proposed model. In particular, some example implementations augment COCO (referred to as Aug-COCO).

TABLE 1
Datasets for pretraining. Some example implementations supervise
different losses based on available annotations.

| | Annotation | Train set size | | | |
|---|---|---|---|---|---|
| Dataset | type | (10³) | L_{object} | L_{assoc} | L_{caption} |
| COCO | Image | 118 | + | | |
| | detection | | | | |
| VG | Image object | 70 | + | | + |
| | captioning | | | | |
| SMiT | Video | 480 | | | + |
| | captioning | | | | |
| Aug-COCO | Video object | 118 | + | + | |
| | tracking | | | | |

### Example Application to Video Object Grounding

The task of video object grounding can include two inputs: a video, V, and a sentence query, c̅. The output is a sequence of bounding boxes, {b^{s}, b^{s+1}, . . . , b^{e}}, corresponding to the sentence query, where s and e are the indices of the start and end frames respectively.

An example proposed model, however, generates captions, c, at the output, rather than accepting it as an input. To apply the proposed model to grounding, some example implementations evaluate the likelihood (e.g., exponential negative cross-entropy loss) of the sentence query, c̅, for each of the object trajectories produced by an example proposed model. In practice, instead of just taking the object trajectory with the highest sentence-likelihood, some example implementations achieve higher accuracy by weighting the likelihood by the detection score. For example, some example implementations run the proposal and tracking modules of an example proposed model to obtain object bounding boxes, detection scores, features, and track ids as {(bₖ^{t}, sₖ^{t}, fₖ^{t}, δₖ^{t})}_{t=1,k=1}^{T,K}^{ₜ}. The box with the highest weighted likelihood can be selected: k*=argmaxₖ(sₖ^{t}·exp(−L_{caption}(Decode(fₖ^{t}), c̅))), b^{t}=b_{k*}^{t}.

### Example Model Diagrams

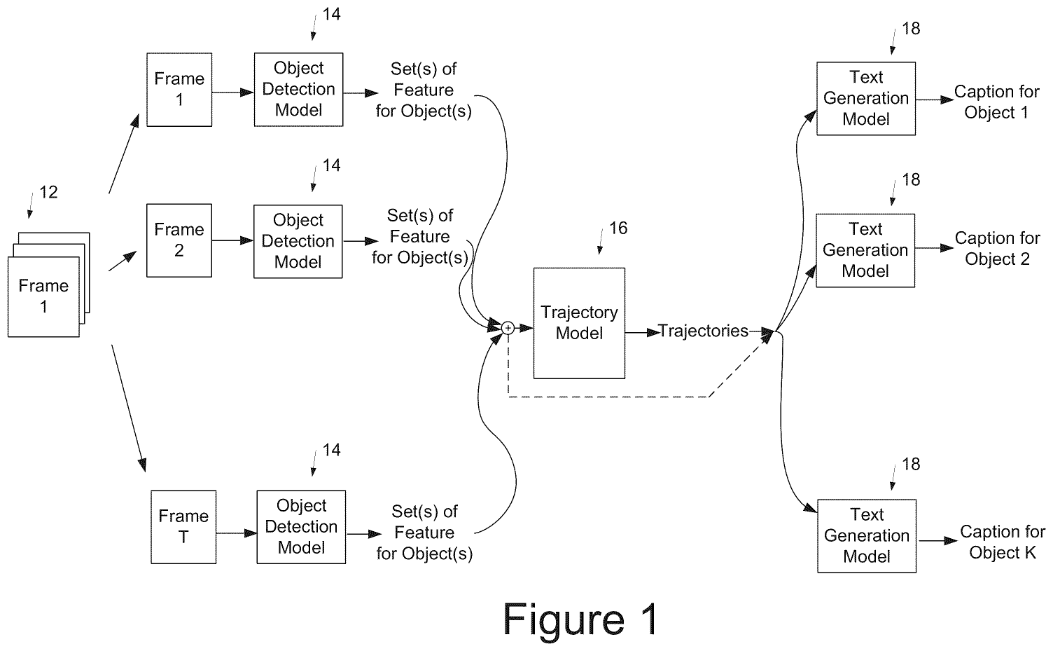

FIG. 1 depicts a graphical diagram of an example dense video object captioning model according to example embodiments of the present disclosure. As shown in FIG. 1, a computing system can obtain a video 12 comprising a plurality of image frames. The video depicts a plurality of objects.

The computing system can respectively process each image frame with a machine-learned object detection model 14 to extract one or more sets of feature data respectively for one or more of the plurality of objects that are depicted in the image frame.

The computing system can process the sets of feature data extracted for the plurality of image frames with a machine-learned tracking model 16 to generate a plurality of trajectories respectively for the plurality of objects. The trajectory for each object identifies the sets of feature data that correspond to the object.

The computing system can respectively process at least some of the respective sets of feature data that correspond to each object with a machine-learned text generation model 18 to generate a textual caption for each object. The computing system provide the textual caption for each object as an output.

FIG. 2 depicts a graphical diagram of an example dense video object captioning model according to example embodiments of the present disclosure. As shown in FIG. 2, the dense video object captioning model includes a region-proposal stage 202, an end-to-end tracking stage 204, and a captioning stage 206.

The region proposal stage 202 shown in FIG. 2 can first produce region proposals per-frame using a machine-learned object detection model. For example, the machine-learned object detection model can be a class-agnostic detector. The detector can be trained with a detection loss L_{object}. As one example, the machine-learned object detection model can be a class-agnostic object detector which takes an image as input and produces object bounding boxes.

The model shown in FIG. 2 can then run a global tracking stage 204 that groups objects into trajectories. This stage 204 can use a machine-learned tracking model. This model can be trained with an association loss L_{assoc}. The tracking model can take object features from all input frames and produces an identity to each object. One example tracking model models the identity prediction as an association matrix between all objects in all frames. The association matrix can be 1 if the two objects in the corresponding row and column are from the same trajectory, and 0 otherwise. The association matrix can be trained with binary cross entropy loss (L_{assoc}).

The trajectory features can then be fed into the captioning stage 206 to produce a caption. The captioning stage 206 can use a machine-learned captioning model. This model can be trained with a caption loss L_{caption}. The captioning model can take both a single-frame feature or a trajectory feature as input.

In particular, the captioning model used in stage 206 can take sequence features as input, and produce sentence tokens in an auto-regressive manner. The input sequence features can be flattened object features (e.g., from RoI pooling) from a single frame, or concatenated trajectory features from multiple frames from an example proposed tracking model. Two trajectory-caption strategies can be employed: hard aggregation.

Because the trajectory of an object can be long, feeding all object features to the captioning model can be expensive. Therefore, in the hard aggregation strategy, some implementations uniformly sample some number (e.g., m=6) frames of the trajectory, and concatenate their features as the trajectory feature.

In the soft aggregation strategy, instead of concatenating object features, some example implementations compute a weighted sum of features in the same trajectory. These implementations can reuse the association matrix predicted by the tracking model and directly compute trajectories features as the matrix-multiplication between the association matrix and the original object features in each frame.

The models used in stages 202-206 can be trained on different and disjoint datasets. The models can provide strong zero-shot performance and/or be subjected to further finetuning.

### Example Devices and Systems

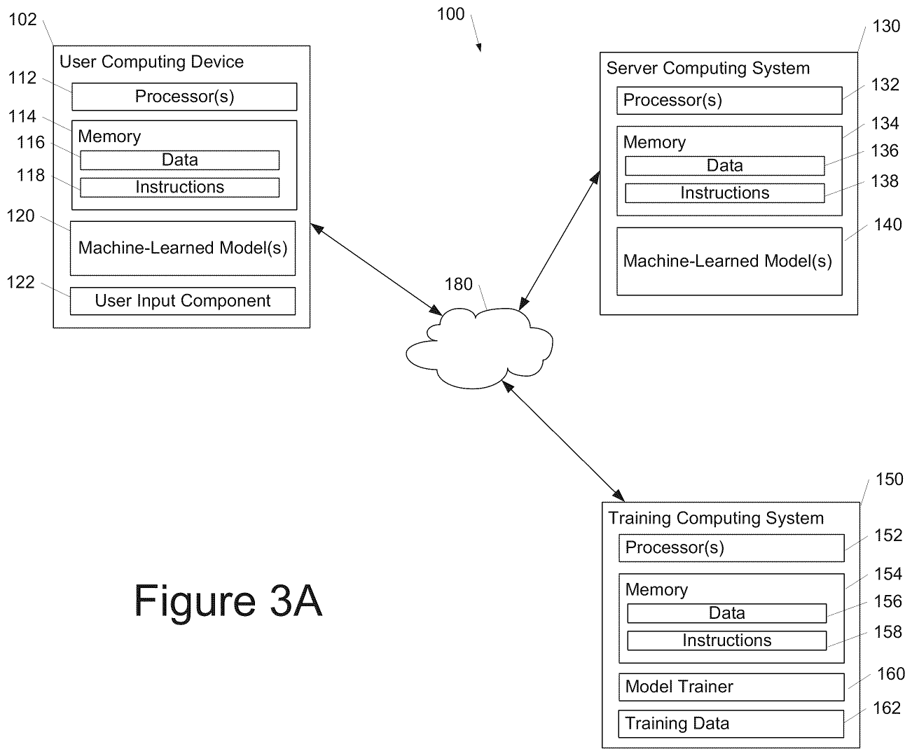

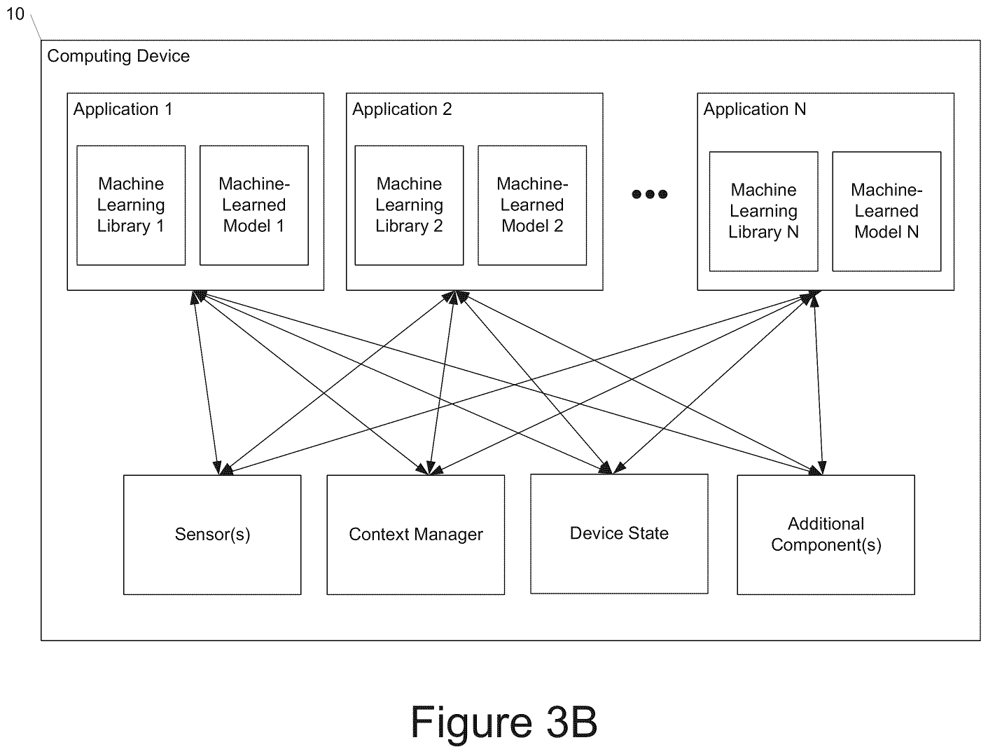

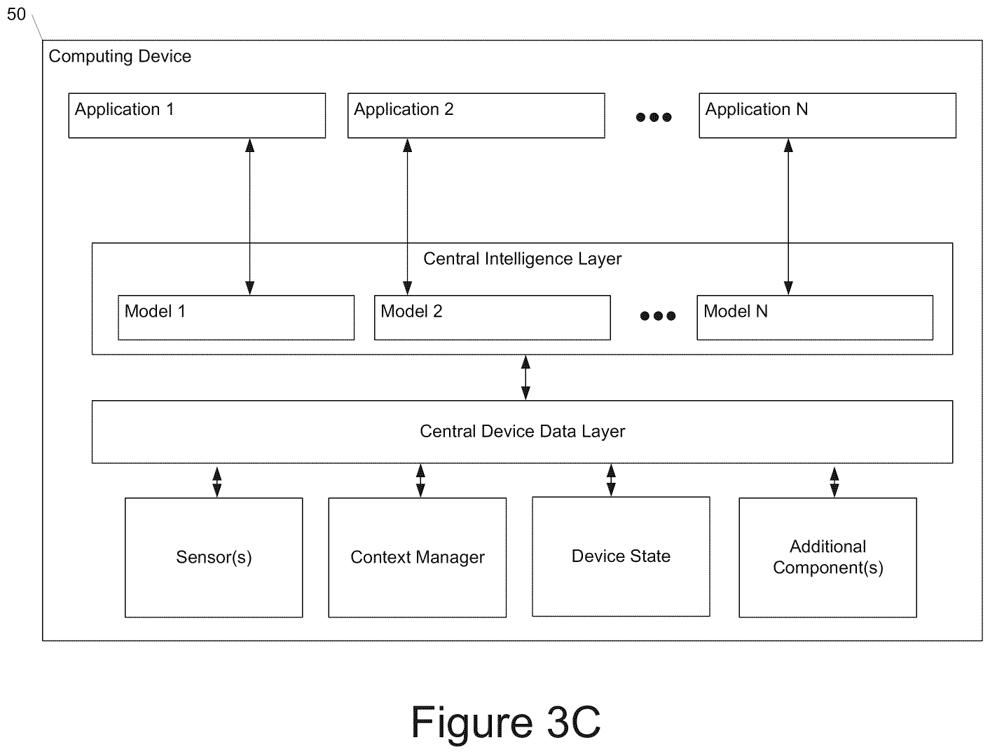

FIG. 3A depicts a block diagram of an example computing system 100 that performs dense VOC according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel dense VOC across multiple instances of videos).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a dense VOC service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, disjoint training data from a number of different disjoint tasks.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP. HTTP. SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations. each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform dense video object captioning, the method comprising:
obtaining, by a computing system comprising one or more computing devices, a video comprising a plurality of image frames, wherein the video depicts a plurality of objects;
respectively processing, by the computing system, each image frame with a machine-learned object detection model to extract one or more sets of feature data respectively for one or more of the plurality of objects that are depicted in the image frame;
processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object;
respectively processing, by the computing system, at least some of the respective sets of feature data that correspond to each object with a machine-learned text generation model to generate a textual caption for each object; and
providing, by the computing system, the textual caption for each object as an output.

2. The computer-implemented method of claim 1, wherein two or more of the machine-learned object detection model, the machine-learned tracking model, and the machine-learned text generation model have been trained on two or more disjoint tasks.

3. The computer-implemented method of claim 2, wherein the two or more disjoint tasks comprise two or more of:
an object detection task;
a dense captioning in images task;
a global video captioning task; and
a tracking task.

4. The computer-implemented method of claim 1, wherein two or more of the machine-learned object detection model, the machine-learned tracking model, and the machine-learned text generation model have been trained jointly together.

5. The computer-implemented method of claim 1, wherein:
the machine-learned object detection model has been trained using an object detection loss function;
the machine-learned tracking model has been trained using an association loss function; and
the machine-learned text generation has been trained using a caption loss function.

6. The computer-implemented method of claim 1, wherein processing, by the computing system, the sets of feature data extracted for the plurality of image frames with the machine-learned tracking model to generate the plurality of trajectories comprises generating, by the computing system using the machine-learned tracking model, a global association matrix that assigns the sets of feature data to the plurality of objects.

7. The computer-implemented method of claim 5, wherein processing, by the computing system, the sets of feature data extracted for the plurality of image frames with the machine-learned tracking model to generate the plurality of trajectories further comprises performing, by the computing system, a greedy grouping algorithm on the global association matrix.

8. The computer-implemented method of claim 1, wherein respectively processing, by the computing system, at least some of the respective sets of feature data that correspond to each object with the machine-learned text generation model to generate the textual caption for each object comprises:
uniformly sampling, by the computing system, from the sets of feature data that correspond to each object to obtain sampled sets of feature data for each object; and
processing, by the computing system, the sampled sets of feature data for each object with the machine-learned text generation model to generate the textual caption for the object.

9. The computer-implemented method of claim 1, wherein respectively processing, by the computing system, at least some of the respective sets of feature data that correspond to each object with the machine-learned text generation model to generate the textual caption for each object comprises:
computing, by the computing system for each object, a weighted sum of features in the trajectory from other image frames; and
processing, by the computing system, the weighted sum of features for each object with the machine-learned text generation model to generate the textual caption for the object.

10. One or more non-transitory computer-readable media that store computer-readable instructions that, when executed by a computing system, cause the computing system to perform operations, the operations comprising:
obtaining, by the computing system, a video comprising a plurality of image frames, wherein the video depicts a plurality of objects;
respectively processing, by the computing system, each image frame with a machine-learned object detection model to extract one or more sets of feature data respectively for one or more of the plurality of objects that are depicted in the image frame and to generate a set of bounding boxes and detection scores for the plurality of objects;
processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object;
obtaining, by the computing system, a textual query; and
identifying, by the computing system based on the set of bounding boxes and detection scores and using a machine-learned text generation model, one or more bounding boxes with a highest weighted likelihood for the textual query.

11. A computing system comprising one or more processors and one or more non-transitory computer-readable media that store computer-readable instructions that, when executed by the one or more processors, cause the computing system to perform operations, the operations comprising:
obtaining, by the computing system, a video comprising a plurality of image frames, wherein the video depicts a plurality of objects;
respectively processing, by the computing system, each image frame with a machine-learned object detection model to extract one or more sets of feature data respectively for one or more of the plurality of objects that are depicted in the image frame;
processing, by the computing system, the sets of feature data extracted for the plurality of image frames with a machine-learned tracking model to generate a plurality of trajectories respectively for the plurality of objects, wherein the trajectory for each object identifies the sets of feature data that correspond to the object;
respectively processing, by the computing system, at least some of the respective sets of feature data that correspond to each object with a machine-learned text generation model to generate a textual caption for each object; and
providing, by the computing system, the textual caption for each object as an output.

12. The computing system of claim 11, wherein two or more of the machine-learned object detection model, the machine-learned tracking model, and the machine-learned text generation model have been trained on two or more disjoint tasks.

13. The computing system of claim 12, wherein the two or more disjoint tasks comprise two or more of:
an object detection task;
a dense captioning in images task;
a global video captioning task; and
a tracking task.

14. The computing system of claim 11, wherein two or more of the machine-learned object detection model, the machine-learned tracking model, and the machine-learned text generation model have been trained jointly together.

15. The computing system of claim 11, wherein:
the machine-learned object detection model has been trained using an object detection loss function;
the machine-learned tracking model has been trained using an association loss function; and
the machine-learned text generation has been trained using a caption loss function.

16. The computing system of claim 11, wherein processing, by the computing system, the sets of feature data extracted for the plurality of image frames with the machine-learned tracking model to generate the plurality of trajectories comprises generating, by the computing system using the machine-learned tracking model, a global association matrix that assigns the sets of feature data to the plurality of objects.

17. The computing system of claim 16, wherein processing, by the computing system, the sets of feature data extracted for the plurality of image frames with the machine-learned tracking model to generate the plurality of trajectories further comprises performing, by the computing system, a greedy grouping algorithm on the global association matrix.

18. The computing system of claim 11, wherein respectively processing, by the computing system, at least some of the respective sets of feature data that correspond to each object with the machine-learned text generation model to generate the textual caption for each object comprises:
uniformly sampling, by the computing system, from the sets of feature data that correspond to each object to obtain sampled sets of feature data for each object; and
processing, by the computing system, the sampled sets of feature data for each object with the machine-learned text generation model to generate the textual caption for the object.

19. The computing system of claim 11, wherein respectively processing, by the computing system, at least some of the respective sets of feature data that correspond to each object with the machine-learned text generation model to generate the textual caption for each object comprises:
computing, by the computing system for each object, a weighted sum of features in the trajectory from other image frames; and
processing, by the computing system, the weighted sum of features for each object with the machine-learned text generation model to generate the textual caption for the object.

20. The computing system of claim 11, wherein the non-transitory computer readable media further stores the machine-learned object detection model, the machine-learned tracking model, and the machine-learned text generation model.
